(19) United States
(12) Patent Application Publication
(10) Pub. No.: US 2026/0329556 A1
(43) Pub. Date: Oct. 22, 2026

(54) MACHINE LEARNING MODEL-BASED INTEGRATION CONFIGURATION

(71) Applicant: Veza Technologies, Inc., Los Gatos, CA (US)

(72) Inventors: Tarun Thakur, Los Gatos, CA (US); Maohua Lu, Fremont, CA (US)

(21) Appl. No.: 19/653,691

(22) Filed: Apr. 21, 2026

Related U.S. Application Data
(60) Provisional application No. 63/792,089, filed on Apr. 21, 2025.

(51) Int. Cl. G06F 8/36; G06F 11/3668; G06F 11/3698

(52) U.S. Cl. CPC G06F 8/36; G06F 11/3688; G06F 11/3698

(57) ABSTRACT

The technology disclosed herein enables configuration of system integrations using multiple machine learning models. In a particular example, a method provides feeding documentation for the new system into a graph machine learning model. The graph machine learning model is trained to identify entities in the documentation, identify relationships between the entities, and create a graph of the entities and the relationships. The method also includes feeding the graph output by the graph machine learning model into a code machine learning model. The code machine learning model is trained to autogenerate code that uses Application Programming Interfaces (APIs). The method further includes feeding the code output by the code machine learning model into a test machine learning model. The test machine learning model tests the code to identify errors and trains the code machine learning model using the errors. Additionally, the method includes implementing the code to integrate the new system.

### RELATED APPLICATIONS

This application is related to and claims priority to U.S. Provisional Patent Application 63/792,089, titled “MACHINE LEARNING MODEL-BASED INTEGRATION CONFIGURATION,” filed Apr. 21, 2025, and which is hereby incorporated by reference in its entirety.

### TECHNICAL BACKGROUND

Application integration is the process of connecting different software applications or systems so they can work together seamlessly. This enables access provisioning and coordination of workflows between applications, allowing for improved efficiency and automation in managing their lifecycle processes. Developers need to code applications to integrate with each other by creating interfaces and protocols that allow them to communicate and share data. This often involves using APIs (Application Programming Interfaces) and other integration tools to ensure compatibility and smooth interaction between the applications. However, with many thousands of known applications out there (and potentially many more custom unknown applications), generating code to account for every possible application integration is near impossible1. Each application may have unique requirements and specifications, making it challenging to create a one-size-fits-all solution. Therefore, developers must often rely on flexible and adaptable integration frameworks that can accommodate a wide range of applications and their specific needs.

### SUMMARY

The technology disclosed herein enables configuration of system integrations using multiple machine learning models. In a particular example, a method provides feeding documentation for the new system into a graph machine learning model. The graph machine learning model is trained to identify entities in the documentation, identify relationships between the entities, and create a graph of the entities and the relationships. The method also includes obtaining the graph output by the graph machine learning model and feeding the graph into a code machine learning model. The code machine learning model is trained to autogenerate code that uses Application Programming Interfaces (APIs). The method further includes obtaining the code output by the code machine learning model and feeding the code into a test machine learning model. The test machine learning model tests the code to identify errors and trains the code machine learning model using the errors. Additionally, the method includes implementing the code to integrate the new system.

In another example, an apparatus is provided having one or more computer readable storage media and a processing system operatively coupled with the one or more computer readable storage media. Program instructions stored on the one or more computer readable storage media, when read and executed by the processing system, direct the apparatus to perform the steps of the above-recited method.

### BRIEF DESCRIPTION OF THE DRAWINGS

FIG. 1 illustrates an implementation for creating a system integration using machine learning models.

FIG. 2 illustrates an operation to create a system integration using machine learning models.

FIG. 3 illustrates an operational scenario to create a system integration using machine learning models.

FIG. 4 illustrates an operational scenario to create a system integration using machine learning models.

FIG. 5 illustrates an operational scenario to create a system integration using machine learning models.

FIG. 6 illustrates an operational scenario to create a system integration using machine learning models.

FIG. 7 illustrates an operational scenario to create a system integration using machine learning models.

FIG. 8 illustrates a computing architecture for creating a system integration using machine learning models.

### DETAILED DESCRIPTION

A Large Language Model (LLM) is a type of artificial intelligence (AI) that uses machine learning techniques to understand, generate, and manipulate human language. These models are trained on vast amounts of text data, enabling them to perform a variety of tasks such as translation, summarization, question answering, and even code generation. In the context of AI, LLMs are particularly valuable for their ability to process and generate natural language, making them useful for applications that require understanding and producing human-like text.

The integration engine described below employs multiple LLMs to automate the generation of code to integrate two or more applications, ensuring seamless interaction between different software systems. A first LLM is tasked with translating the documentation of an application, such as Snowflake, MongoDB, APIs, and RBAC, into a graph model. This involves identifying entities like users, groups, roles, permissions, resources, permission sets, and ACLs, and mapping out their relationships. By feeding the documentation into a graph machine learning model like the first LLM, the first LLM creates a structured representation of the application's components and their interactions.

Once the graph model is created, it is fed into a second LLM. This second model is trained to automatically generate code based on the graph model, including the appropriate APIs to use. The APIs as well as other coding conventions may be documented in the same documentation used by the first LLM or the second LLM may be trained on other documentation for the application. The second LLM leverages the documented information to produce code that facilitates the integration of the application with other systems. This process ensures that the generated code is compatible with the application's specifications and can effectively communicate with other software.

A third LLM is responsible for writing tests for the auto-generated code. This third model tests the code to identify any errors and ensures that it functions correctly. By feeding the code into the third LLM, developers can verify the accuracy and reliability of the generated code, making necessary adjustments to improve its performance. The test results from the third LLM may be used to further train the second LLM. As the third LLM identifies errors and trains the second LLM using these errors, the second LLM becomes better at generating accurate code. This iterative process allows both models to improve over time, resulting in more efficient and reliable code generation for application integrations.

By leveraging the above LLMs, developers can automate the process of code generation and testing, significantly reducing the time and effort required for application integrations. This approach not only enhances efficiency but also ensures that the generated code is robust and reliable, facilitating seamless interaction between different software systems.

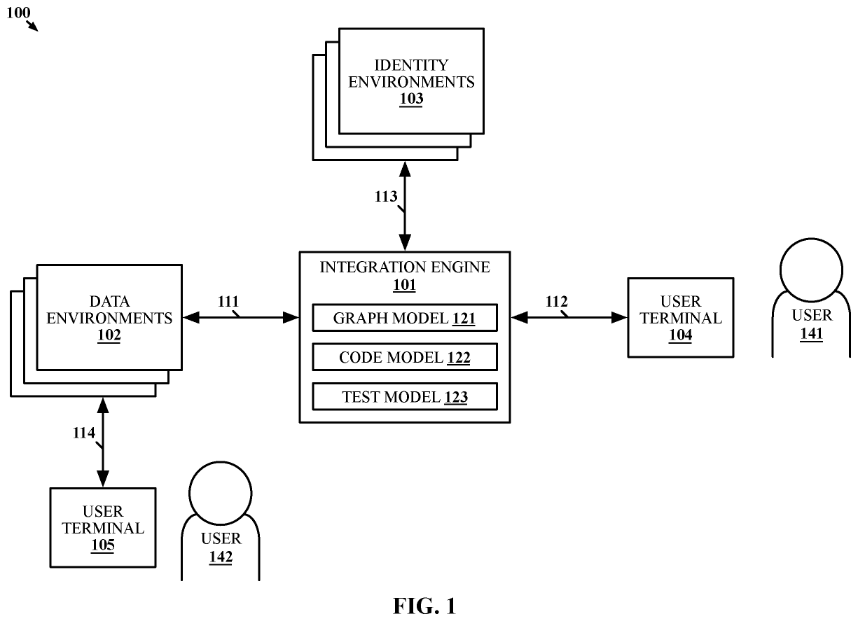

FIG. 1 illustrates an implementation for creating a system integration using machine learning models. Implementation 100 includes integration engine 101, data environments 102, identity environments 103, user terminal 104, and user terminal 105. Integration engine 101 and data environments 102 communicate over respective communication links 111. Integration engine 101 and user terminal 104 communicate over communication link 112. Data environments 102 and user terminal 105 communicate over communication link(s) 114. Integration engine 101 and identity environments 103 communicate over respective communication links 113. While communication links 111-114 are shown as direct links, communication links 111-113 may include intervening systems, networks, and/or devices. Integration engine 101 executes on one or more computing systems, such as server systems, having processing and communication circuitry to operate as described below. User terminals 104 and 105 are each a user operated computing system, such as a desktop workstation, laptop, tablet computer, smartphone, etc. User terminal 104 is operated by an administrative user 141 controls integration engine 101. User terminal 105 is operated by user 142 who accesses resources provided by data environments 102.

In operation, integration engine 101 handles the integration of a new system (e.g., physical hardware or a software product executing on existing hardware) into data environments 102. Data environments 102 include one or more systems that host databases, such as databases for Online Transaction Processing (OLTP) and Online Analytical Processing (OLAP), tables, files, applications, or other computing resources provided to accessing systems—including combinations thereof. Identity environments 103 include one or more systems that maintain information about users (e.g., user identity information, user attributes, etc.) and information about which of data environments 102 (including specific resources therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access particular resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user's job title/role, a seniority of the user, a security clearance level for the user, or any other type of information that may affect which of data environments 102 the user can access. In further examples, a data environment of data environments 102 may authorize users independently.

Regardless of the arrangement between data environments 102 and identity environments 103 to determine access privileges of users, systems in data environments 102 are configured to interact with one another to work as intended by an operating entity, such as a business that maintains data environments 102 for use by employees of the business. For example, user 142 may use user terminal 105 to use services, applications, or data provided by data environments 102 in accordance with permissions assigned to user 142. Traditionally, administrative user 141 may be tasked with integrating new systems into data environments 102. When a vendor of a new system (or of a system the new system is being integrated with) has not predefined how the new system can interact with the existing systems, user 141 will have to configure the application themselves. That may involve user 141 looking through documentation for the involved systems and producing instructions (e.g., computing code) for the systems to run that enables the systems to interact with each other as desired by user 141. As the number of available systems increases, the chances that a new system is already defined for integration with another becomes slimmer. Thus, creating integrations between existing systems and new systems becomes more and more tedious.

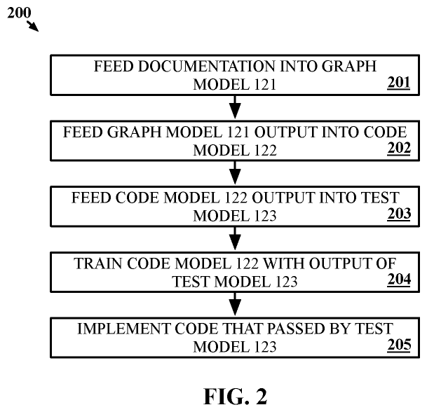

FIG. 2 illustrates operation 200 to create a system integration using machine learning models. Integration engine 101 feeds documentation for a new system into graph model 121 (step 201). Graph model 121 is a machine learning model trained to identify entities in the documentation, identify relationships between the entities, and create a graph of the entities and the relationships. The graph is not necessarily something that is displayed to a user but, rather, could be displayed as connections in the graph representing the relationships between entities, which are represented by nodes of the graph. The documentation may be supplied by user 141 to integration engine 101 via user terminal 104. For example, user 141 may receive the documentation from the vendor supplying the new system, user 141 may navigate user terminal 104 to an online repository of documentation for the new system, or user 141 may obtain the documentation in computer-readable format from some other source. Alternatively, integration engine 101 may retrieve the documentation from a source other than user 141. For example, integration engine 101 may identify the new system and search for documentation concerning the new system (e.g., perform an internet search). The documentation may describe entities, relationships, coding conventions, syntax, Application Programming Interfaces (APIs), or other information about the features of the new system and how to configure the new system. The documentation may also include similar information about one or more other systems already in data environments 102 should those systems also need configuration to integrate with the new system. In some examples, user 141 may review the graph to ensure the graph is properly identifying entities and their relationships. User 141 may provide feedback to graph model 121 to further train graph model 121 for better results in the future.

Integration engine 101 obtains the graph output by graph model 121 and feeds the graph into code model 122 (step 202). Code model 122 is a machine learning model trained to autogenerate code that uses Application Programming Interfaces (APIs). Code model 122 may be trained using the same documentation that was used to train graph model 121. In such examples, code model 122 may be trained to focus on APIs and other information pertinent to drafting code that can be used to integrate the new system into data environments 102, while graph model 121 may be trained to focus on the entity relationship aspects of the documentation. Although, in other examples, the documentation used to train graph model 121 may differ from that used to train code model 122. The generated code ensures the entities and relationships identified in the graph are reflected in the operation of the new system.

Integration engine 101 obtains code output by code model 122 and feeds the code into test model 123 (step 203). Test model 123 is a machine learning model that tests the code to identify errors. For example, test model 123 may be trained to emulate the new system and systems with which the new system is to integrate. If a result is unexpected (e.g., data is not shared in an expected manner), then test model 123 will identify an error. The output of test model 123 is used to train code model 122 to prevent the errors from reoccurring during future code generation (step 204). Integration engine 101 may have code model 122 regenerate the code after training and retest the code using test model 123, which may occur again and again until no errors are found. Alternatively, user 141 may correct the errors in the code manually.

Integration engine 101 then implements the code to integrate the new system (step 205). For example, the code may be supplied to the new system for execution thereat. If code for other systems was also generated, then integration engine 101 will supply that code to those systems as well. The systems receiving code execute the code in the same manner as they would have had user 141 drafted the code themselves.

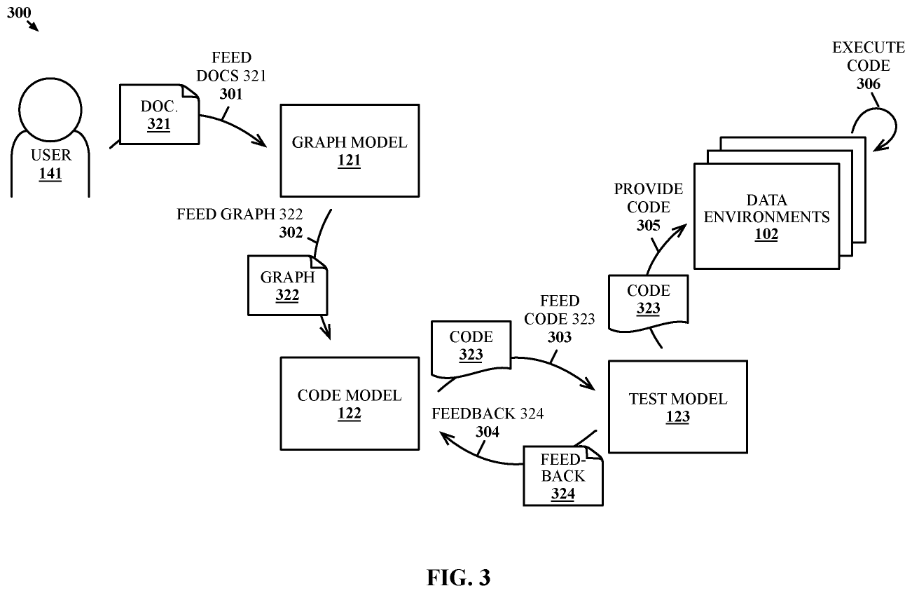

FIG. 3 illustrates operational scenario 300 to create a system integration using machine learning models. In operational scenario 300, user 141 feeds system documentation 321 into graph model 121 (step 301). System documentation 321 is documentation providing information on how a new system can be configured to integrate with one or more systems in data environments 102. System documentation 321 may be no different than documentation a human user can consume to learn what is needed to write code for the new system to integrate with the other systems. Graph model 121 is trained to parse such human-readable information, which avoids user 141 having to translate system documentation 321 into a different format.

Graph model 121 generates graph 322, which integration engine 101 feeds into code model 122 (step 302). Code model 122 is similarly trained on system documentation 321 to determine parameters defined for interactions between the new system and other systems in data environments 102. For example, an existing system in data environments 102 may provide an API for other systems to use when interacting with the existing system. Code model 122 consumed documentation for that existing system like it did system documentation 321 to recognize the API. As such, code model 122 will generate code for the new system that calls the API of the existing system to interact with that existing system. Code 323 is generated in this example to implement the entity relationships indicated in graph 322.

Integration engine 101 feeds code 323 into test model 123 (step 303). Test model 123 determines whether the code will achieve the desired effect of integrating the new system into data environments 102. Should test model 123 identify errors where code 323 does not produce the desired effect (e.g., crashes, loops, performs a different action, etc.), test model 123 outputs information identifying those errors as feedback 324. Feedback 324 may also provide information about correcting the error. For instance, if test model 123 determined an incorrect syntax was used causing the error, then test model 123 may indicate the correct syntax. Integration engine 101 uses feedback 324 to further train code model 122 (step 304). Code model 122 may then regenerate code 323 based on the new training using feedback 324. Steps 303 and 304 may repeat until test model 123 determines code 323 is error free or otherwise determines with a threshold amount of certainty that code 323 will integrate the new system into data environments 102 properly.

Integration engine 101 provides the passing version of code 323 to systems in data environments 102 for which code has been generated (step 305). That is, portions of code 323 may be generated for the new system and/or systems in data environments 102 with which the new system will interact. The systems in data environments 102 receiving code 323 execute the code completing integration of the new system (step 306).

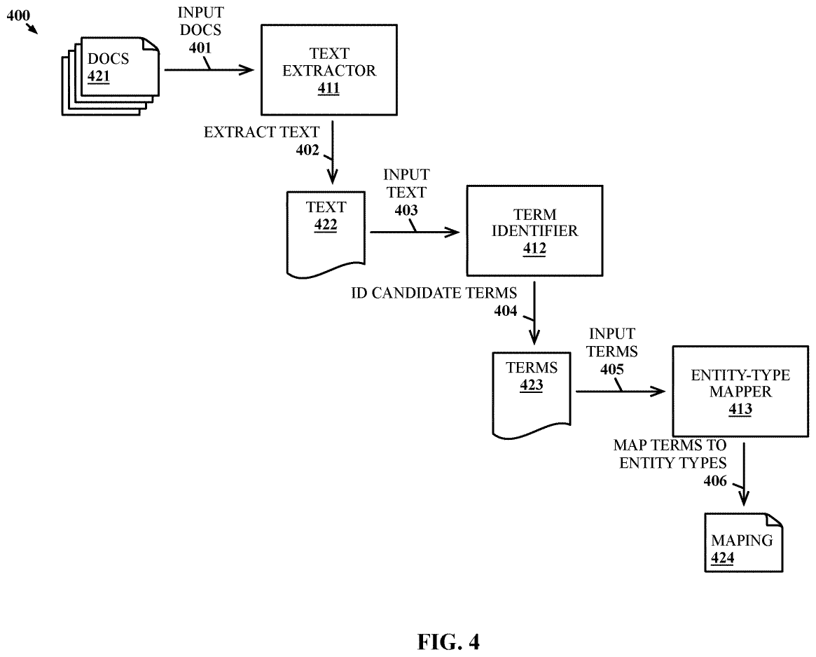

FIG. 4 illustrates operational scenario 400 to create a system integration using machine learning models. Operational scenario 400 involves text extractor 411, term identifier 412, and entity-type mapper 413, which may be implemented as components of graph model 121 or as distinct functions performed by graph model 121 to generate a graph representation of a new system. In operational scenario 400, documentation 421 describing the new system is input into text extractor 411 (step 401). Documentation 421 may include vendor documentation, configuration guides, API references, RBAC descriptions, schema definitions, example payloads, or other materials that describe how the new system represents users, resources, permissions, or interactions with other systems.

Text extractor 411 extracts both structured and unstructured text 422 from the input documentation 421 (step 402). Structured text may include tables, schemas, field definitions, or formatted parameter lists, while unstructured text may include narrative descriptions, examples, or explanatory prose intended for human readers. In some examples, text extractor 411 normalizes the extracted text by removing formatting, resolving references, expanding abbreviations, or separating text into tokens, sentences, or sections to facilitate downstream analysis. Text extractor 411 outputs extracted text 422, which is provided to term identifier 412 (step 403).

Term identifier 412 analyzes text 422 to identify candidate terms 423 (step 404). Candidate terms 423 may include nouns, noun phrases, identifiers, keywords, or phrases that potentially correspond to entities, attributes, or relationships within the new system. In some examples, term identifier 412 applies natural-language processing techniques such as part-of-speech tagging, named-entity recognition, dependency parsing, or pattern matching against known vocabularies for identity systems, databases, or APIs. Candidate terms 423 may include explicit identifiers such as “user,” “role,” “permission,” or “resource,” as well as system-specific terms defined by the documentation author. Candidate terms 423 are provided to entity-type mapper 413 (step 405).

Entity-type mapper 413 maps terms from candidate terms 423 to entity types (step 406). Mapping 424 indicates which of candidate terms 423 are classified as which types of entities. Entity-type mapper 413 may map candidate terms 423 to predefined categories representing users, groups, roles, permissions, resources, applications, services, or other system components relevant to integration. In some examples, entity-type mapper 413 uses a predefined ontology or taxonomy of entity types to ensure consistent classification across different systems. In other examples, entity-type mapper 413 learns entity-type mappings based on labeled training data or feedback from previously integrated systems. Mapping 424 may also include confidence scores indicating the likelihood that a candidate term corresponds to a particular entity type, enabling graph model 121 to resolve ambiguities or defer classification when confidence is below a threshold. The resulting mapping 424 provides a structured representation of how terms in documentation 421 correspond to entities within the new system, which may serve as an input to subsequent graph construction operations described in later figures.

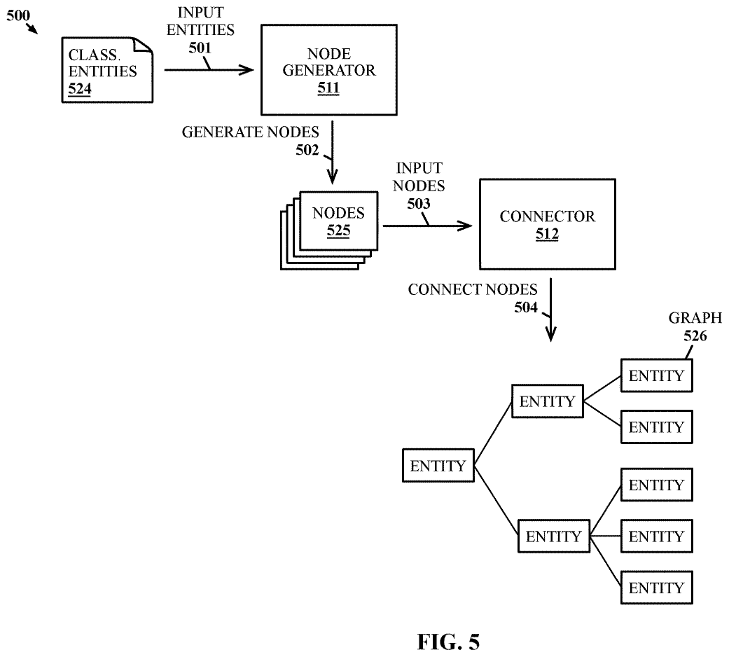

FIG. 5 illustrates operational scenario 500 to create a system integration using machine learning models. Operational scenario 500 involves node generator 511 and connector 512, which may be implemented as components of graph model 121 or as distinct functions performed by graph model 121 to generate a graph representation from classified entities. In operational scenario 500, classified entities 524 are input into node generator 511 (step 501). Classified entities 524 may be derived from mapping 424 and represent entities identified in documentation 421 that have already been associated with specific entity types, such as users, roles, groups, permissions, resources, applications, or services.

Node generator 511 generates nodes 525 representing the entities included in classified entities 524 (step 502). Each of nodes 525 corresponds to an individual entity and may include attributes describing the entity, such as an identifier, a type, one or more properties extracted from documentation 421, or metadata indicating a source location within documentation 421. In some examples, node generator 511 generates different node structures depending on the entity type, such that a user node includes identity attributes while a resource node includes scope, location, or access semantics. Nodes 525 may also be tagged with confidence values or provenance information indicating how the entity was derived, which enables downstream processing to resolve ambiguities or refine the graph over time.

Graph nodes 525 are provided to connector 512 (step 503). Connector 512 connects graph nodes 525 with edges that correspond to relationships between the entities represented by graph nodes 525 (step 504). The relationships may be derived from relationships identified in documentation 421, inferred from contextual usage of candidate terms 423, or learned from previously integrated systems. In some examples, connector 512 creates directed edges to indicate asymmetric relationships, such as a user having access to a resource, while in other examples bi-directional edges may be used to represent associations such as group membership. Connector 512 may also encode attributes on edges, such as access type, scope, conditions, inheritance behavior, or dependency order.

Graph 526 is the result of connecting graph nodes 525 using connector 512. Graph 526 provides a structured, machine-readable representation of entities and their relationships within the new system. In some examples, graph 526 is stored in a graph database, serialized into an intermediate representation, or maintained in memory for immediate use by code model 122. Graph 526 may be validated to ensure required entity types and relationship patterns are present before being passed downstream. For example, graph model 121 may verify that permission nodes are connected to both identity-related nodes and resource-related nodes, ensuring that the graph can support generation of executable integration code. In other examples, graph 526 may be iteratively refined based on feedback from subsequent processing stages, enabling adjustments to node creation or edge connections when errors or omissions are identified later in the integration workflow.

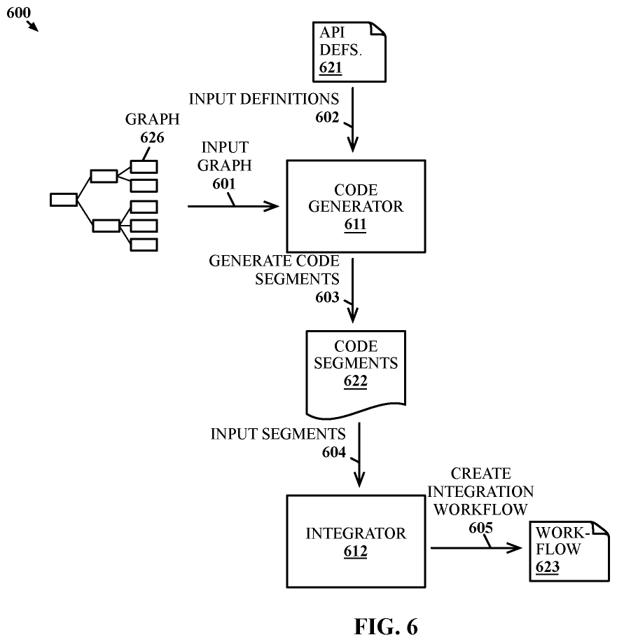

FIG. 6 illustrates operational scenario 600 to create a system integration using machine learning models. Operational scenario 600 involves code generator 611 and integrator 612, which may be implemented as components of code model 122 or as different functions performed by code model 122 to generate executable integration code. In operational scenario 600, graph 626 is input into code generator 611 (step 601). Graph 526 may be an example of graph 626 and represents a structured description of entities and relationships identified for the new system. API definitions 621 are also input into code generator 611 (step 602). API definitions 621 may include documentation-derived descriptions of endpoints, parameters, authentication mechanisms, response formats, rate limits, or sequencing constraints for application programming interfaces exposed by the new system or by other systems to be integrated with the new system.

Code generator 611 analyzes graph 626 in conjunction with API definitions 621 to determine how relationships represented in graph 626 should be implemented programmatically. In step 603, code generator 611 generates code segments 622 that correspond to individual integration actions or configuration steps. Each of code segments 622 may implement a discrete operation, such as creating an identity, assigning a role, establishing a permission, querying metadata, or synchronizing information between systems. In some examples, code generator 611 selects specific APIs from API definitions 621 based on entity types and relationships represented in graph 626, and generates code segments 622 that invoke those APIs with parameters derived from attributes stored in graph 626. Code segments 622 may be generated in one or more programming languages, configuration formats, or scripting languages depending on the requirements of the systems being integrated.

Code segments 622 are provided to integrator 612 (step 604). Integrator 612 integrates code segments 622 to create integration workflow 623 (step 605). Integration workflow 623 represents an ordered or structured sequence of code segments that collectively implement the integration of the new system. In some examples, integrator 612 determines an execution order for code segments 622 based on dependencies between entities or relationships identified in graph 626, such as requiring that an entity be created before permissions referencing that entity are applied. Integrator 612 may also insert control logic, error handling, retries, or conditional branching into integration workflow 623 to account for expected variations in system behavior or configuration state.

Integration workflow 623 may additionally include metadata identifying which portions of the workflow correspond to which entities or relationships in graph 626. This association enables later analysis or debugging if errors occur during testing or deployment. In some examples, integrator 612 produces integration workflow 623 in a form that can be directly executed by integration engine 101 or scheduled for execution in data environments 102. In other examples, integration workflow 623 may be stored as an intermediate artifact that is subsequently modified, tested, or augmented by test model 123 before being implemented.

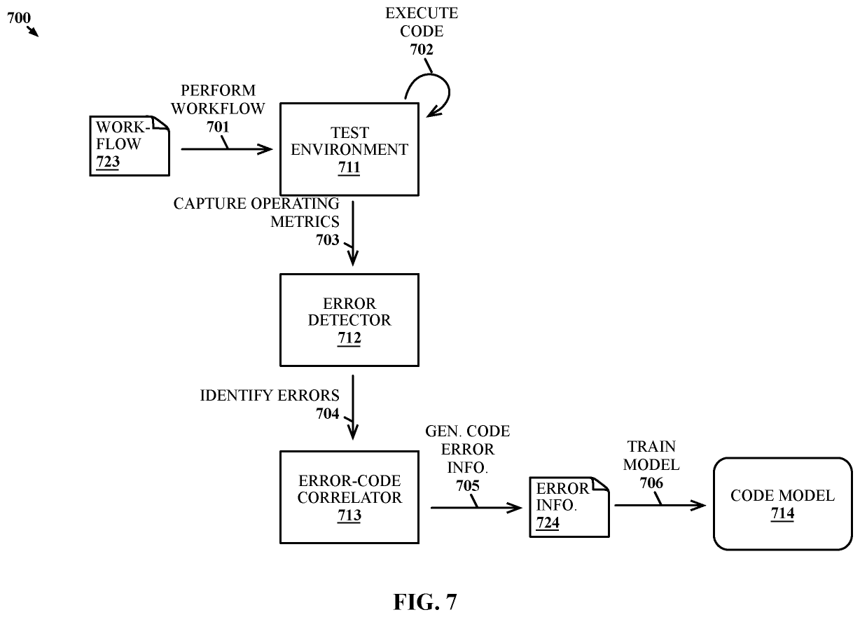

FIG. 7 illustrates operational scenario 700 to create a system integration using machine learning models. Operational scenario 700 involves test environment 711, error detector 712, and error-code correlator 713, which may be used by test model 123 to evaluate generated integration code before deployment to a production environment. In operational scenario 700, integration workflow 723 is performed to integrate the new system into test environment 711 (step 701). Integration workflow 623 may be an example of integration workflow 723 and may include a sequence of code segments that implement entity creation, relationship assignment, permission configuration, or data synchronization actions derived from graph 626 and API definitions 621.

Test environment 711 simulates a production environment, such as data environments 102 and identity environments 103, while isolating execution from live systems. Test environment 711 may emulate APIs, authentication mechanisms, permission behaviors, and data responses of production systems, or may correspond to a dedicated sandbox, staging environment, or tenant configured to mirror production settings. Test environment 711 executes the code within integration workflow 723 (step 702) and produces operational outputs corresponding to the executed integration actions. During execution, error detector 712 captures operating metrics (step 703), which may include API responses, error codes, execution latency, permission-denied events, unexpected state transitions, or other indicators of integration behavior.

Error detector 712 analyzes the captured metrics to identify errors (step 704). Errors may include syntax errors in the generated code, logical errors that cause incorrect sequencing or incomplete configuration, authorization failures resulting from missing or incorrect permissions, or discrepancies between expected and observed system states. In some examples, error detector 712 compares observed outcomes against expected behaviors derived from graph 626 or integration workflow 723, enabling detection of deviations even when code executes without explicit runtime failures. Error detector 712 forwards detected errors to error-code correlator 713.

Error-code correlator 713 determines which of the code segments included in integration workflow 723 are responsible for which of the detected errors (step 705). To perform this correlation, error-code correlator 713 may associate error events with specific API calls, execution steps, or code segments based on execution traces, timestamps, or instrumentation embedded in integration workflow 723. Error-code correlator 713 generates error information 724 that maps errors to corresponding code segments, error types, and contextual information describing execution conditions.

Error information 724 is provided to code model 714, which is an example of code model 122, and is used to train code model 714 to improve code generated in the future (step 706). In addition to or instead of training code model 714, error information 724 may be provided to graph model 121 to update how entities or relationships are inferred from documentation. For example, if an error indicates that a relationship was missing or incorrectly inferred, graph model 121 may be updated to adjust entity classification or relationship extraction logic for subsequent integrations. In some examples, error information 724 is used to train both graph model 121 and code model 122, enabling coordinated improvement of graph generation and code generation based on observed execution behavior.

Training code model 714 using error information 724 may involve adjusting model parameters to avoid generating code patterns that resulted in errors, refining API selection logic, or modifying sequencing assumptions encoded within the model. After training, code model 714 may be used to regenerate some or all of the code segments in integration workflow 723 to correct for the identified errors, after which the updated integration workflow may be re-tested in test environment 711. While operational scenario 700 illustrates training based on behavior observed in test environment 711, similar feedback mechanisms may be applied when executing integration workflows in a production environment, for example to capture edge cases, emerging API changes, or configuration differences not represented during testing.

Training of graph model 121, code model 122, and test model 123 may occur using data collected across multiple integration attempts involving different new systems. In some examples, integration engine 101 logs error information, execution metrics, and training outcomes generated during testing and runtime execution of multiple integration workflows. The logged information may be aggregated to identify recurring error patterns, frequently misclassified entities, or common API invocation failures. Aggregated error information may then be used to retrain at least one of graph model 121, code model 122, or test model 123 using a training dataset that spans multiple systems and integrations. This enables the machine learning models to generalize from prior integrations and improve accuracy and reliability when integrating subsequent new systems.

In addition to testing performed within test environment 711, integration engine 101 may monitor execution of integration workflows deployed to a runtime environment after implementation in data environments 102. In such examples, integration engine 101 may capture operational metrics generated during live execution of the integration workflow, including API responses, authorization outcomes, data synchronization results, timing information, and execution failures. Integration engine 101 may compare the captured operational metrics to expected behaviors derived from graph 626 or from a persisted representation of integration workflow 723. When a deviation is detected, such as an unexpected authorization denial or a data update that does not propagate as expected, integration engine 101 may generate deviation information identifying the discrepancy. The deviation information may be provided to graph model 121 to update entity or relationship representations, to code model 122 to adjust code generation patterns, or to both models. In this manner, integration engine 101 enables continuous post-deployment learning based on runtime execution behavior, allowing future integrations to account for conditions that were not present or detectable during execution in test environment 711.

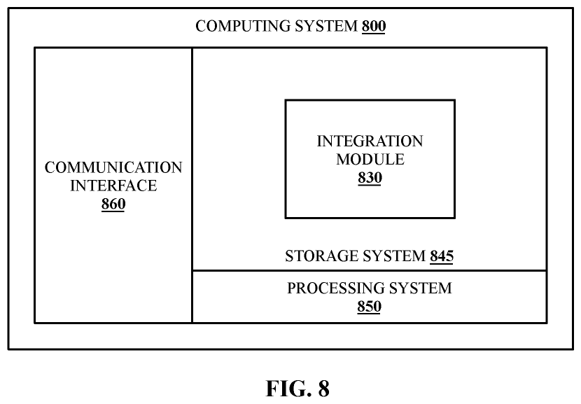

FIG. 8 illustrates computing architecture 800 for creating a system integration using machine learning models. Computing architecture 800 is representative of any computing system or systems with which the various operational architectures, processes, scenarios, and sequences disclosed herein can be implemented. Computing architecture 800 is an example architecture for integration engine 101, data environments 102, identity environments 103, user terminal 104, and user terminal 105, although other examples may exist. Computing architecture 800 includes storage system 845, processing system 850, and communication interface 860. Processing system 850 is operatively linked to communication interface 860 and storage system 845. Communication interface 860 may be communicatively linked to storage system 845 in some implementations. Computing architecture 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format including combinations thereof. Communication interface 860 may be configured to communicate with other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as “signals per se”), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises integration module 830. The operating software on storage system 845 may further include an operating system, utilities, drivers, network interfaces, applications, or some other type of software. When read and executed by processing system 850 the operating software on storage system 845 directs computing architecture 800 to integrate systems as described herein. Integration module 830 may execute natively on processing system 850 or the operating software may include virtualization software, such as a hypervisor, to virtualize computing hardware on which integration module 830 executes.

In at least one example, integration module 830 executes on processing system 850 and directs computing architecture 800 to feed documentation for the new system into a graph machine learning model. The graph machine learning model is trained to identify entities in the documentation, identify relationships between the entities, and create a graph of the entities and the relationships. Integration module 830 also directs computing architecture 800 to obtain the graph output by the graph machine learning model and feed the graph into a code machine learning model. The code machine learning model is trained to autogenerate code that uses Application Programming Interfaces (APIs). Integration module 830 further directs computing architecture 800 to obtain the code output by the code machine learning model and feed the code into a test machine learning model. The test machine learning model tests the code to identify errors and trains the code machine learning model using the errors. Additionally, integration module 830 directs computing architecture 800 to implement the code to integrate the new system.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for leveraging machine learning models to configure an integration with a new system, the method comprising:
feeding documentation for the new system into a graph machine learning model, wherein the graph machine learning model is trained to identify entities in the documentation, identify relationships between the entities, and create a graph of the entities and the relationships;
obtaining the graph output by the graph machine learning model;
feeding the graph into a code machine learning model, wherein the code machine learning model is trained to autogenerate code that uses Application Programming Interfaces (APIs);
obtaining the code output by the code machine learning model;
feeding the code into a test machine learning model, wherein the test machine learning model tests the code to identify errors and trains the code machine learning model using the errors; and
implementing the code to integrate the new system.

2. The method of claim 1, wherein feeding the documentation into the graph machine learning model comprises:
extracting text, structured and unstructured, from the documentation;
identifying candidate entity types from the text; and
associating the candidate entity types with predefined categories representing users, roles, permissions, resources, or system components.

3. The method of claim 1, wherein creating the graph comprises:
creating nodes representing the entities;
creating edges representing access, dependency, or membership relationships between the entities; and
encoding the nodes and the edges in a machine-readable graph representation.

4. The method of claim 1, wherein feeding the graph into the code machine learning model comprises:
identifying the APIs described in the documentation;
associating portions of the graph with corresponding APIs; and
generating executable code that invokes the APIs to implement the relationships.

5. The method of claim 1, wherein obtaining the code comprises:
generating configuration code for the new system;
generating integration code for at least one existing system; and
linking the configuration code and the integration code into an executable integration workflow.

6. The method of claim 1, wherein feeding the code into the test machine learning model comprises:
executing the code in a simulated environment;
monitoring execution behavior against expected behaviors derived from the graph; and
identifying at least one of a syntax error, logical error, or authorization failure.

7. The method of claim 6, wherein training the code machine learning model using the errors comprises:
classifying each identified error;
correlating the errors to code segments that caused the errors; and
updating parameters of the code machine learning model to reduce recurrence of the errors.

8. The method of claim 1, wherein implementing the code comprises:
deploying the code to a production environment;
executing API calls to establish at least one integration function; and
verifying the integration based on successful API responses or system state changes.

9. The method of claim 1, further comprising:
after implementing the code to integrate the new system, monitoring execution of the code in a runtime environment;
detecting at least one deviation between observed runtime behavior and an expected behavior derived from the graph; and
updating at least one of the graph machine learning model or the code machine learning model based on the at least one deviation.

10. An apparatus for automatically configuring an integration with a new system, the apparatus comprising:
one or more computer-readable storage media;
a processing system operatively coupled with the one or more computer-readable storage media; and
program instructions stored on the one or more computer-readable storage media that, when read and executed by the processing system, direct the apparatus to:
use a graphing model to create a graph of entities identified in documentation for the new system and relationships identified between the entities;
use a coding model to generate code for implementing the integration from the graph;
use a testing model to test the code to identify errors and train the graphing model for subsequent code generation; and
after the code is tested, executing the code to integrate the new system.

11. The apparatus of claim 10, wherein the program instructions directing use of the graphing model direct the apparatus to:
parse natural-language documentation;
map extracted terms to entity types; and
generate graph nodes and edges corresponding to the entity types and the relationships.

12. The apparatus of claim 10, wherein the program instructions directing use of the coding model direct the apparatus to:
select APIs associated with the relationships;
generate code segments invoking the APIs; and
combine the code segments into an executable integration routine.

13. The apparatus of claim 10, wherein the program instructions directing use of the testing model direct the apparatus to:
execute the code in a test environment;
compare execution outputs to expected outputs derived from the graph; and
generate error data identifying deviations between actual and expected outputs.

14. The apparatus of claim 13, wherein the program instructions further direct the apparatus to:
provide the error data to the coding model;
update parameters of the coding model based on the error data; and
regenerate the code after the parameters are updated.

15. The apparatus of claim 10, wherein executing the code to integrate the new system comprises:
deploying the code to a runtime environment;
initiating API calls to establish access control or data exchange; and
detecting successful integration based on API responses.

16. A method for integrating a new system, the method comprising:
training a graphing model to identify entities in documentation for new systems, identify relationships between the entities, and create graphs of the entities and the relationships;
training a coding model to autogenerate integration code that uses Application Programming Interfaces (APIs) of other systems;
training a testing model to identify coding errors and further train the coding model to avoid the coding errors;
inputting new-system documentation to the graphing model; and
implementing code output by the graphing model using the new-system documentation after the code passes the testing model.

17. The method of claim 16, wherein training the graphing model comprises:
providing annotated documentation identifying known entities and the relationships;
adjusting model parameters based on annotation accuracy; and
validating graph outputs against reference graphs.

18. The method of claim 16, wherein training the coding model comprises:
providing training graphs paired with known correct integration code;
training the coding model to associate graph patterns with API call sequences; and
validating generated code against expected integration behaviors.

19. The method of claim 16, wherein training the testing model comprises:
executing faulty code examples;
labeling detected errors by error category; and
training the testing model to identify similar errors to the detected errors in subsequently generated code.

20. The method of claim 16, further comprising:
logging detected errors identified by the testing model across multiple integration attempts;
aggregating the detected errors into aggregated errors; and
retraining at least one of the graphing model, the coding model, or the testing model using the aggregated errors.
